(19) United States
(12) Patent Application Publication
(10) Pub. No.: US 2008/0315998 A1
(43) Pub. Date: Dec. 25, 2008

(54) Trigger Arrangement for a Multi-function Device

(76) Inventor: John FIORIGLIO, Rocky Point, NY (US)

Correspondence Address: FAY KAPLUN & MARCIN, LLP, 150 BROADWAY, SUITE 702, NEW YORK, NY, 10038, US

(21) Appl. No.: 11/766,539

(22) Filed: Jun. 21, 2007

(51) Int. Cl. H04B 1/00

(52) U.S. Cl. 340/10.3

(57) ABSTRACT

Described is a device including a first functional component, a second functional component and a control unit coupled to and capable of activating the first and second components. The device further includes a trigger arrangement coupled to the control unit, and at least one sensor coupled to the control unit and capable of detecting when the trigger arrangement is in one of a first triggering position and a second triggering position. When the at least one sensor detects that the trigger arrangement is activated and in the first triggering position, the control unit activates the first component and when the at least one sensor detects that the trigger arrangement is activated and in the second triggering position, the control unit activates the second component.

### FIELD OF INVENTION

The present application generally relates to trigger arrangements for multi-function devices.

### BACKGROUND INFORMATION

Electronic devices often include multiple functionalities (e.g., functional components) that are accessed by activating trigger arrangements. Individual functions may be accessed using separate trigger arrangements, a combination of trigger arrangements or multiple activations of the same trigger arrangement.

### SUMMARY OF THE INVENTION

The present invention relates to a device including a first functional component, a second functional component and a control unit coupled to and capable of activating the first and second components. The device further includes a trigger arrangement coupled to the control unit, and at least one sensor coupled to the control unit and capable of detecting when the trigger arrangement is in one of a first triggering position and a second triggering position. When the at least one sensor detects that the trigger arrangement is activated and in the first triggering position, the control unit activates the first component and when the at least one sensor detects that the trigger arrangement is activated and in the second triggering position, the control unit activates the second component.

The present invention also relates to a method including the steps of detecting an activation of a trigger arrangement of a device and detecting whether the trigger arrangement is in one of a first triggering position and a second triggering position. When the trigger arrangement has been detected as activated and in the first triggering position, a first component of the device is activated and when the trigger arrangement is detected as activated and in the second triggering position, a second component of the device is activated.

The present invention also relates to a trigger arrangement including a trigger mechanism operable between first and second triggering positions. When the trigger mechanism is activated and in the first triggering position, a first component of a device is activated and when the trigger mechanism is activated and in the second triggering position, a second component of the device is activated.

The present invention also relates to a device including a first functional component, a second functional component and a control means coupled to and capable of activating the first and second components. The device further includes a trigger means coupled to the control means, and at least one sensing means coupled to the control means and capable of detecting when the trigger means is in one of a first triggering position and a second triggering position. When the at least one sensing means detects that the trigger means is activated and in the first triggering position, the control means activates the first component and when the at least one sensing means detects that the trigger means is activated and in the second triggering position, the control means activates the second component.

### BRIEF DESCRIPTION OF THE DRAWINGS

FIG. 1 shows a multi-function device according to the present invention.

FIG. 2 shows a block diagram of the device of FIG. 1.

FIG. 3 shows a trigger arrangement according to the present invention.

FIG. 4 shows a method according to the present invention.

### DETAILED DESCRIPTION

The present invention may be further understood with reference to the following description and the appended drawings, wherein like elements are provided with the same reference numerals. The present invention relates to trigger arrangements for multi-function devices. Various embodiments of the present invention will be described with reference to a multi-function device comprising a combination of a bar code scanner and a radio-frequency identification (“RFID”) reader. However, those skilled in the art will understand that the present invention may be implemented with any electronic device which has multiple functionalities. For example, the electronic device may be a mobile or portable device such as a laptop, a cell phone, a personal digital assistant, a global positioning system handheld, a portable radio, a digital camera, etc. The electronic device may also be a stationary device such as a desktop computer, a television set, a wall-mounted appliance, a corded telephone, etc.

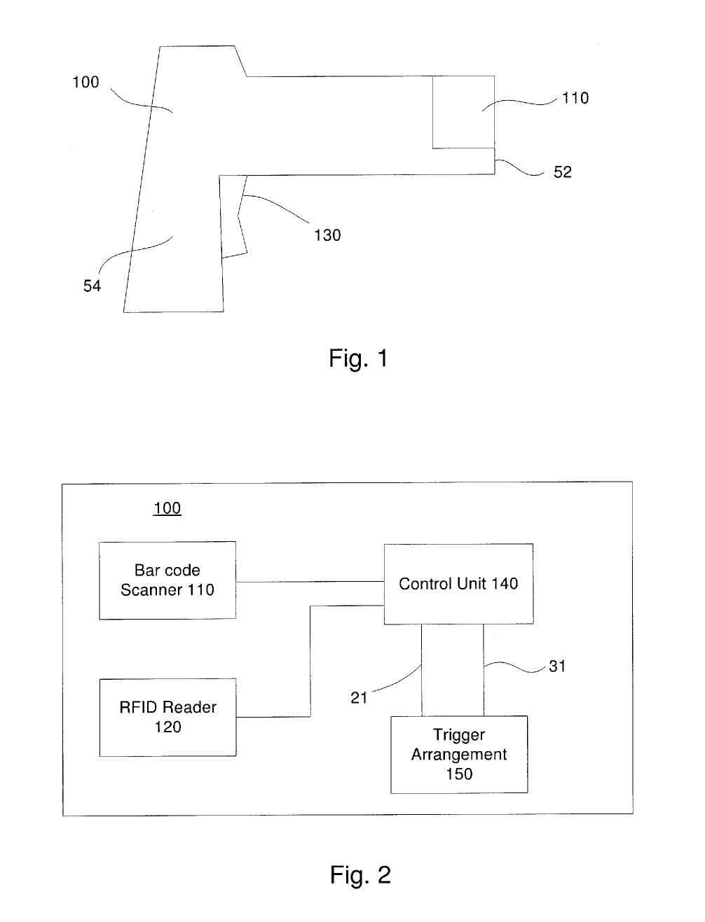

FIG. 1 shows a profile view of an exemplary embodiment of a multi-function device 100 according to the present invention. The device 100 may be a handheld device comprising a bar code scanner 110 and an RFID reader (not shown). The bar code scanner 110 may be located at a distal portion 52 of a housing of the device 100 and may comprise any bar code imaging device known in the art. For example, the bar code scanner 110 may be a laser-based bar code imager capable of scanning two-dimensional bar codes.

The RFID reader may include a wireless arrangement that produces RF interrogation signals, which may induce responses in nearby RF devices (e.g., RFID tags). The RFID reader may be located within an interior of the housing, such as behind the bar code reader 110, in a handle portion 54 of the housing, in a proximal portion, etc. The RFID reader may also include an antenna, which in an exemplary embodiment, may be housed internally. In other embodiments, the antenna may be an external antenna coupled to internally housed portions of the RFID reader.

In the exemplary embodiment described above with reference to FIG. 1, the functions of the device 100 (e.g., bar code scanning and reading RFID tags) are both data acquisition functions. Thus, the RFID reader and the bar code scanner 110 may be used in a complementary fashion. For example, a user may alternately enable the RFID reader and the bar code scanner 110 to acquire data from packages that are respectively labeled with RFID tags and bar codes. However, those skilled in the art will understand that the present invention is not limited to enabling similar functionalities. That is, in other embodiments, functions may be unrelated. For example, a first function may be a data acquisition function while a second function may be multimedia function.

As shown in FIG. 1, the device 100 may also include a trigger such as a gun-style trigger 130 that is activated by squeezing the trigger 130 against the handle 54. In accordance with the teachings of the present invention, the trigger 130 is a multi-position trigger including a plurality of triggering positions. For example, a first position may activate the bar code scanner 110 while a second position may activate the RFID reader. As will be described in further detail below, the trigger 130 may comprise part of a trigger arrangement that determines and/or indicates whether the trigger 130 is being activated and, if so, whether the trigger 130 is in the first position or the second position.

FIG. 2 shows a block diagram of an exemplary embodiment of the device 100 according to the present invention. As discussed above, the device 100 may include the bar code scanner 110 and the RFID reader (e.g., an RFID reader 120). The device 100 may also include a control unit 140 which controls operation of the bar code scanner 110 and the RFID reader 120 based on input from a trigger arrangement 150. The control unit 140 may include a microprocessor, an embedded controller, an application-specific integrated circuit (“ASIC”), etc. and may comprise a finite state machine that includes idle and triggering states (e.g., an RFID triggering state and a bar code triggering state). The control unit 140 may be implemented in hardware, software, or any combination thereof and receives at least one input signal from the trigger arrangement 150. For example, the control unit 140 may receive a first input signal 21 and a second input signal 31, which respectively inform the control unit 140 that the trigger 130 has been placed in the first and second triggering positions.

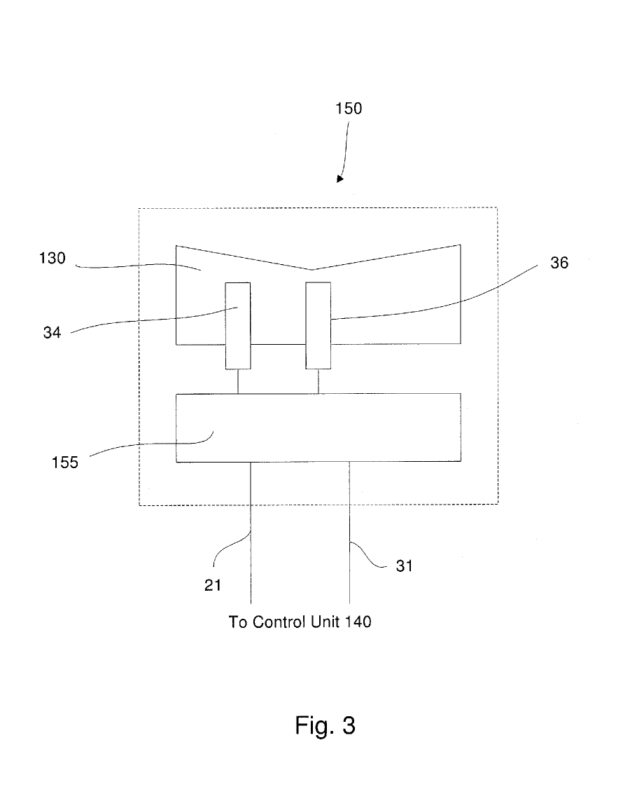

FIG. 3 shows a cut-away view of an exemplary embodiment of the trigger arrangement 150 according to the present invention. The trigger arrangement 150 includes the trigger 130 and may further include a first sensor 34 and a second sensor 36. In one exemplary embodiment, the sensors 34, 36 may be push button switches, which are activated when pushed against by activating the trigger 130. However, those skilled in the art will understand that other types of sensors may be equally suitable for implementation in the present invention. Thus, other embodiments may utilize contact switches, pressure sensors, proximity sensors, etc.

According to the exemplary embodiment shown in FIG. 3, when the trigger 130 is placed in one of the two triggering positions, at least one of the sensors 34, 36 are activated. The trigger 130 may be activated by a combination of simultaneously squeezing the trigger 130 and displacing the trigger 130 towards one of the first and the second triggering positions. For example, the displacing may be a rotation of the trigger 130 about a central axis thereof, causing one end of the trigger 130 to come into closer proximity to the handle 54. If, for instance, the trigger 130 is placed in the first triggering position, the rotation may cause the trigger 130 to contact the sensor 34. Application of sufficient rotational force may then cause activation of the sensor 34. Simultaneously, a portion of a force exerted by the user in rotating the trigger 130 towards the first triggering position also creates a downward force on the sensor 36, thereby activating it. However, if the trigger 130 is rotated towards the second triggering position, the rotation may only cause the sensor 36 to be activated. Thus, in either of the triggering positions, the sensor 36 may be activated to indicate that the trigger 130 is being activated. Furthermore, the activation of the sensor 34 enables a triggering circuit 155 to determine whether the trigger 130 has been placed in the first or the second triggering position.

The triggering circuit 155 may be any combination of hardware and/or software and may be coupled to the sensors 34, 36. In one embodiment, the triggering circuit 155 may be a signal buffer that provides a minimal amount of signal processing (e.g., storing or filtering) before asserting one of the first and second input signals 21, 31 to the control unit 140. Thus, the triggering circuit 155 may relay the output of the sensors 34, 36 directly to the control unit 140, which then performs the determination of the trigger position.

The signal 31 may be an interrupt signal that, once detected by the control unit 140, causes the control unit 140 to read a status of the signal 21. In this manner, when a switch corresponding to activating of the trigger 130 (e.g., the switch 36) is activated, a status of a switch corresponding to trigger position (e.g., the switch 34) is determined.

Alternatively, in another embodiment, the triggering circuit 155 may perform a determination of whether the trigger 130 has been successfully placed in either of the first or the second triggering positions. Thus, the triggering circuit 155 may compare the output of the sensors 34, 36 to one or more threshold values (e.g., a threshold voltage). If the threshold value(s) are met, the input signals 21, 31 may then be asserted.

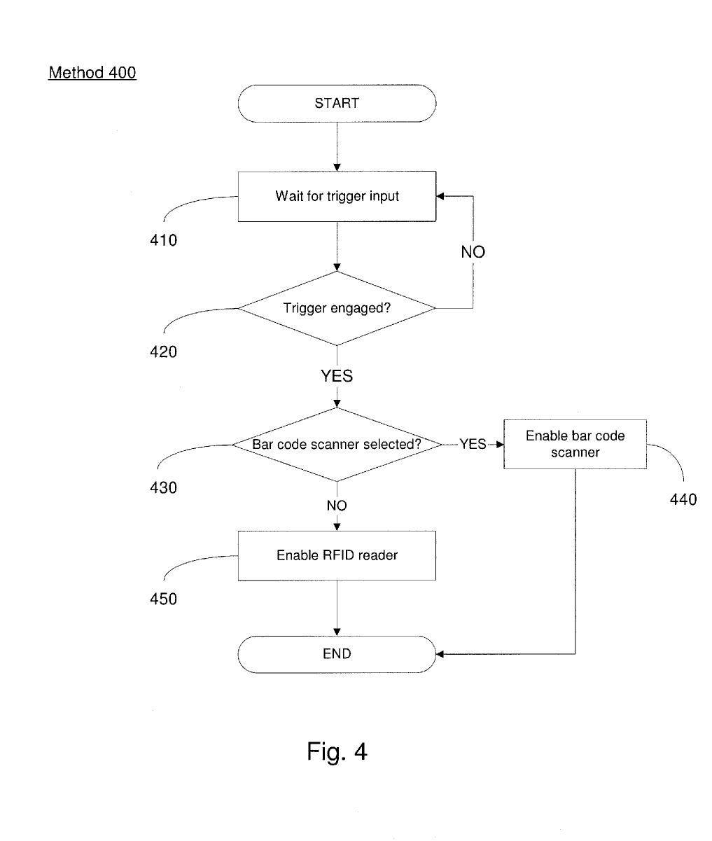

FIG. 4 shows an exemplary embodiment of a method 400 according to the present invention. The method 400 will be described with reference to the exemplary embodiments of the device 100 discussed above. In step 410, the device 100 waits for trigger input from the user. For example, in one embodiment, the trigger arrangement 150 may wait in an idle mode for activation of the sensors 34, 36. In another embodiment, the trigger arrangement 150 may periodically poll the sensors 34, 36 to determine whether there has been a recent activation.

In step 420, the device 100 determines whether the trigger 130 has been activated. The control unit 140 may perform this determination by monitoring the signals 21, 31. As previously discussed, the signal 31 may be an interrupt signal that, once asserted, informs the control unit 140 that the trigger 130 has been activated and prompts a reading of the status of the signal 21 (e.g., determining a state of the switch 34) and the method 400 proceeds to step 430. If the signal 31 is not asserted, then the trigger 130 has not been activated and the method 400 returns to step 410.

In step 430, the trigger 130 has been activated and the device 100 determines whether the bar code scanner 110 has been selected. This determination is based on detecting that the signal 21 has been asserted (e.g., the trigger 130 has been placed in the first triggering position). Consequently, in step 440, the control unit 140 enables the bar code scanner 110.

In step 450, the signal 31 is asserted (e.g., the trigger 130 has been placed in the second triggering position) and the control unit 140 enables the RFID reader 120. When the control unit 140 enables the RFID reader 120, the bar code scanner 110 may be disabled if it is currently enabled. Similarly, the RFID reader 120 may be disabled when the bar code scanner 110 is enabled in step 440. Thus, an enabling of a first functionality may require disabling of all other functionalities. However, this may not be true of other embodiments, in which two or more functionalities may be simultaneously enabled.

The present invention, as described in the exemplary embodiments above, provides significant advantages over conventional triggering arrangements. The device 100 enables access to multiple functions using a single trigger (e.g., the trigger 130). Additional trigger arrangements, triggering mechanisms and complicated triggering methods are unnecessary as a result of implementing the present invention. Because less material is used to manufacture a multi-function device, the present invention results in reduced manufacturing costs in addition to increased operating convenience.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A device, comprising:
a first functional component;
a second functional component;
a control unit coupled to and capable of activating the first and second components;
a trigger arrangement coupled to the control unit; and
at least one sensor coupled to the control unit and capable of detecting when the trigger arrangement is in one of a first triggering position and a second triggering position,
wherein when the at least one sensor detects that the trigger arrangement is activated and in the first triggering position, the control unit activates the first component and when the at least one sensor detects that the trigger arrangement is activated and in the second triggering position, the control unit activates the second component.

2. The device according to claim 1, wherein the first component is an RFID reader.

3. The device according to claim 1, wherein the second component is a bar code scanner.

4. The device according to claim 1, wherein the trigger arrangement includes a mechanical trigger.

5. The device according to claim 1, wherein the activation of the trigger arrangement is detected by a first sensor of the at least one sensor and wherein the detecting of when the trigger arrangement is in one of the first triggering position and the second triggering position is performed by a second sensor of the at least one sensor.

6. The device according to claim 5, wherein the detection of the activation produces an interrupt signal.

7. The device according to claim 6, wherein the detection of the activation initiates a determination of a status of the second sensor.

8. The device according to claim 1, wherein when the control unit enables one of the first and second components, the control unit disables the other of the first and second components.

9. A method, comprising:
detecting an activation of a trigger arrangement of a device; and
detecting if the trigger arrangement is in one of a first triggering position and a second triggering position;
wherein when the trigger arrangement has been detected as activated and in the first triggering position, a first component of the device is activated and when the trigger arrangement is detected as activated and in the second triggering position, a second component of the device is activated.

10. The method according to claim 9, wherein the first component is an RFID reader.

11. The method according to claim 9, wherein the second component is a bar code scanner.

12. The method according to claim 9, wherein the trigger arrangement includes a mechanical trigger.

13. The method according to claim 9, wherein the activation of the trigger arrangement is detected by a first sensor and wherein the detecting of when the trigger arrangement is in one of the first triggering position and the second triggering position is performed by a second sensor.

14. The method according to claim 13, wherein the detection of the activation produces an interrupt signal.

15. The method according to claim 14, wherein the detection of the activation initiates a determination of a status of the second sensor.

16. The method according to claim 9, further comprising:
disabling one of the first and second components when the other of the first and second components is enabled.

17. The method according to claim 13, wherein the first sensor is a mechanical switch.

18. A trigger arrangement, comprising:
a trigger mechanism operable between first and second triggering positions,
wherein when the trigger mechanism is activated and in the first triggering position, a first component of a device is activated and when the trigger mechanism is activated and in the second triggering position, a second component of the device is activated.

19. An arrangement, comprising:
a first means;
a second means;
a controlling means coupled to and capable of activating the first and second means;
a triggering means coupled to the control means; and
at least one sensing means coupled to the controlling means and capable of detecting when the triggering means is in one of a first triggering position and a second triggering position;
wherein when the at least one sensing means detects that the triggering means is activated and in the first triggering position, the controlling means activates the first means and when the at least one sensing means detects that the triggering means is activated and in the second triggering position, the controlling means activates the second means.
